(19) United States
(12) Patent Application Publication
(10) Pub. No.: US 2020/0098073 A1
(43) Pub. Date: Mar. 26, 2020

(54) SYSTEM AND METHOD FOR PROVIDING TUTORING AND MENTORING SERVICES

(71) Applicant: Quynn Le, Morgan Hill, CA (US)

(72) Inventors: Quynn LE, JR., Morgan Hill, CA (US); Mark DURANTE, Houston, TX (US); Thinh TO, San Jose, CA (US)

(21) Appl. No.: 16/584,779

(22) Filed: Sep. 26, 2019

Related U.S. Application Data
(60) Provisional application No. 62/736,733, filed on Sep. 26, 2018.

(51) Int. Cl. G06Q 50/20; G09B 5/14

(52) U.S. Cl. CPC G06Q 50/205; G09B 5/14

(57) ABSTRACT

A system and method for providing mentoring services includes receiving a mentoring request from a mentee. The mentoring request identifies areas or sub-areas of expertise or experience and logistical information. The system and method further include matching mentors to the mentoring request, ranking each of the matching mentors based on an aggregation of ratings, providing a list of mentors matching the mentoring request and the ranking to the mentee, receiving a selection of acceptable mentors from the mentee, sending a mentorship request to the acceptable mentors, receiving responses from the acceptable mentors, sending a list of the acceptable mentors providing an affirmative response to the mentee, receiving a selection of a mentor from the list of acceptable mentors providing an affirmative response from the mentee, and facilitating scheduling of mentoring between the mentee and the selected mentor. The ratings are based on previous feedback about each respective mentor.

### RELATED APPLICATIONS

This application claims priority to U.S. Provisional Patent Application No. 62/736,733, filed Sep. 26, 2018 and titled “System and Method for Providing Tutoring Services,” which is incorporated by reference.

### TECHNICAL FIELD

The present disclosure relates generally to the providing of tutoring and mentoring services and more particularly to determining the most appropriate tutor to assign to a student or mentor to assign to a mentee.

### BACKGROUND

Services for finding tutors for students have existed for a long time. However, the mechanisms used to assign tutors to students and/or mentors to mentees are typically simplistic and do not often do a good job of matching an appropriate tutor to the student and/or mentor to the mentee. In some examples, the matching strategy typically selects the first tutor or mentor that is available who also has a broad subject matter and/or area of expertise match to the student and/or mentee (e.g., a tutor for algebra, a mentor for business formation, and/or the like). This tends to select a tutor and/or mentor that does not best meet the needs of the student and/or mentee.

Accordingly, it would be advantageous to provide improved methods of providing tutoring and/or mentoring services that provide a more appropriate match between the tutor and student and/or the mentor and mentee.

### SUMMARY

Consistent with some embodiments, a method includes receiving a mentoring request from a mentee. The mentoring request identifies one or more areas or sub-areas of expertise or experience and logistical information. The method further includes matching one or more mentors to the mentoring request based on the one or more areas or sub-areas of expertise or experience and the logistical information, ranking each of the one or more mentors matching the mentoring request based on an aggregation of ratings for each respective mentor, providing a list of the one or more mentors matching the mentoring request and the ranking to the mentee, receiving a selection of one or more acceptable mentors from the list of the one or more mentors matching the mentoring request from the mentee, sending a mentorship request to each of the one or more acceptable mentors, receiving responses from one or more of the one or more acceptable mentors, sending a list of the one or more acceptable mentors providing an affirmative response to the mentee, receiving a selection of a mentor from the list of the one or more acceptable mentors providing an affirmative response from the mentee, and facilitating scheduling of mentoring between the mentee and the selected mentor. The ratings are based on previous feedback about each respective mentor received based on previous mentoring.

Consistent with some embodiments, a computing device includes a memory and a processor coupled to the memory. The processor is configured to receive a mentoring request from a mentee. The mentoring request identifies one or more areas or sub-areas of expertise or experience and logistical information. The processor is further configured to match one or more mentors to the mentoring request based on the one or more areas or sub-areas of expertise or experience and the logistical information, rank each of the one or more mentors matching the mentoring request based on an aggregation of ratings for each respective mentor, provide a list of the one or more mentors matching the mentoring request and the ranking to the mentee, receive a selection of one or more acceptable mentors from the list of the one or more mentors matching the mentoring request from the mentee, send a mentorship request to each of the one or more acceptable mentors, receive responses from one or more of the one or more acceptable mentors, sending a list of the one or more acceptable mentors providing an affirmative response to the mentee, receive a selection of a mentor from the list of the one or more acceptable mentors providing an affirmative response from the mentee, and facilitate scheduling of mentoring between the mentee and the selected mentor. The ratings are based on previous feedback about each respective mentor received based on previous mentoring.

Consistent with some embodiments, a non-transitory machine-readable medium comprising a plurality of machine-readable instructions which when executed by one or more processors associated with computing device are adapted to cause the one or more processors to perform a method. The method includes receiving a mentoring request from a mentee. The mentoring request identifies one or more areas or sub-areas of expertise or experience and logistical information. The method further includes matching one or more mentors to the mentoring request based on the one or more areas or sub-areas of expertise or experience and the logistical information, ranking each of the one or more mentors matching the mentoring request based on an aggregation of ratings for each respective mentor, providing a list of the one or more mentors matching the mentoring request and the ranking to the mentee, receiving a selection of one or more acceptable mentors from the list of the one or more mentors matching the mentoring request from the mentee, sending a mentorship request to each of the one or more acceptable mentors, receiving responses from one or more of the one or more acceptable mentors, sending a list of the one or more acceptable mentors providing an affirmative response to the mentee, receiving a selection of a mentor from the list of the one or more acceptable mentors providing an affirmative response from the mentee, and facilitating scheduling of mentoring between the mentee and the selected mentor. The ratings are based on previous feedback about each respective mentor received based on previous mentoring.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

FIG. 1 is a simplified diagram of a computing system according to some embodiments.

FIG. 2 is a simplified diagram of a method of providing tutoring services according to some embodiments.

FIG. 3 is a simplified diagram of a method of determining the appropriateness of a tutor according to some embodiments.

In the figures, elements having the same designations have the same or similar functions.

### DETAILED DESCRIPTION

This description and the accompanying drawings that illustrate inventive aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail in order not to obscure the invention. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Elements described in detail with reference to one embodiment, implementation, or module may, whenever practical, be included in other embodiments, implementations, or modules in which they are not specifically shown or described. For example, if an element is described in detail with reference to one embodiment and is not described with reference to a second embodiment, the element may nevertheless be claimed as included in the second embodiment. Thus, to avoid unnecessary repetition in the following description, one or more elements shown and described in association with one embodiment, implementation, or application may be incorporated into other embodiments, implementations, or aspects unless specifically described otherwise, unless the one or more elements would make an embodiment or implementation non-functional, or unless two or more of the elements provide conflicting functions.

In some instances, well known methods, procedures, components, and circuits have not been described in detail so as not to unnecessarily obscure aspects of the embodiments.

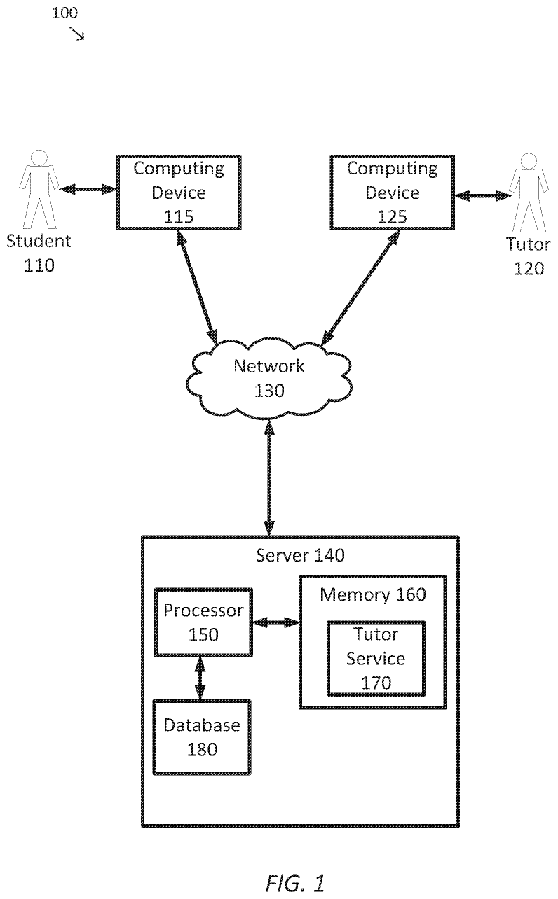

FIG. 1 is a simplified diagram of a computing system 100 according to some embodiments. As shown in FIG. 1, computing system 100 includes at least two users, a student 110 and a tutor 120. Student 110 accesses computing system 100 using a computing device 115 and tutor 120 accesses computing system 100 using a computing device 125. In some examples, each of computing devices 115 and 125 may correspond to a computer, desktop, laptop, tablet, smart phone, and/or other end user computing device. And although computing system 100 is shown with only a single student 110 with corresponding computing device 115 and a single tutor 120 with corresponding computing device 125, computing system 100 may further include any number of additional students and additional tutors with corresponding computing devices.

Each of computing devices 115 and 125 is coupled to a network 130. Network 130 may be used to access a tutoring service. In some examples, network 130 may include a combination of one or more of a wireless network, a wired network (e.g., an Ethernet), a cellular network, a local area network, a wide area network (e.g., the Internet), and/or the like.

Student 110 and tutor 120 use computing devices 115 and 125, respectively, and network 130 to access a server 140, such as in a client-server relationship. In some examples, server 140 may be operated by a tutoring service. Server 140 includes a processor 150 coupled to memory 160. Operation of server 140 is controlled by processor 150. And although server 140 is shown with only one processor 160, it is understood that processor 160 may be representative of one or more central processing units, multi-core processors, microprocessors, microcontrollers, digital signal processors, field programmable gate arrays (FPGAs), application specific integrated circuits (ASICs), graphics processing units (GPUs), and/or the like in server 140. And although server 140 is shown as a stand-alone device, server 140 may optionally be part of a virtual machine, provided as a cloud service, and/or the like.

Memory 160 may be used to store software executed by server 140 and/or one or more data structures used during operation of server 140. Memory 160 may include one or more types of machine-readable media. Some common forms of machine-readable media may include floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

As shown, memory 160 includes a tutor service module 170. Tutor service module 170 is responsible for maintaining information about the users of a tutoring service (e.g., students and tutors), taking requests from students for tutoring in specific subjects, identifying tutors suitable for the request, coordinating the selection of an acceptable tutor by the student making the request, and collecting post-tutoring feedback that may be used to improve the selection of future tutors for students as is discussed in further detail below.

Server 140 further includes a database 180. Database 180 may be used to store information on behalf of tutor service module 170. The stored information may include information about the students and/or tutors, results of feedback, and/or the like. And although database 180 is shown as part of server 140, database 180 may alternatively be separate from server 140.

Many tutor selection services do a superficial job of identifying tutors for students that often does not assign a very appropriate tutor to the student. In some examples, these tutor selection services consider only basic logistical factors (e.g., location and availability) and a high-level subject matter match to a student's request. As an example, a tutoring service may select an algebra tutor for a student located in a particular city for tutoring at a specific date and time. In some examples, the tutoring service may additionally select a tutor based on the first tutor that responds to a tutoring request. This matching often does not take into account the specific subject matter of the tutoring (e.g., fractions), the learning style of the student, the ability of the tutor to be an effective tutor for the specific subject matter, and/or the like. This may often result in a poor and unhelpful tutoring experience that results in poor student outcomes and poor retention of students as users of the tutoring service.

Accordingly, an improved tutoring service should be able to consider more factors when selecting tutors for a student including one or more of the specific subject matter of the tutoring, the learning style of the student, the ability of the tutor to be effective for the specific subject matter, and/or the like. And with better selection of tutors, student tutoring outcomes would improve and retention of students as customers of the tutoring service would increase.

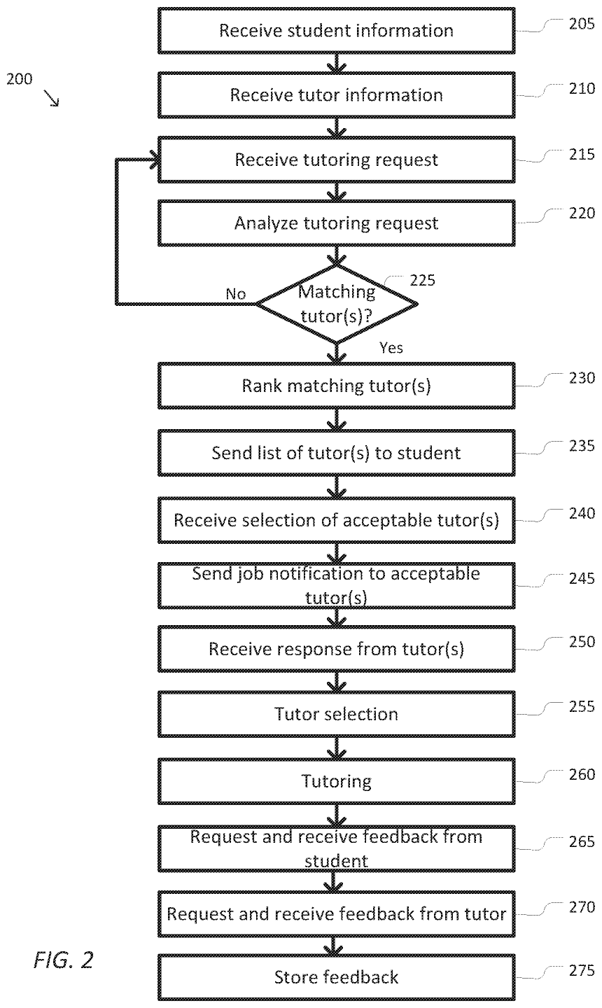

FIG. 2 is a simplified diagram of a method 200 of providing tutoring services according to some embodiments. One or more of the processes 205-275 of method 200 may be implemented, at least in part, in the form of executable code stored on non-transitory, tangible, machine-readable media that when run by one or more processors (e.g., the processor 150 in server 140) may cause the one or more processors to perform one or more of the processes 205-275. In some embodiments, one or more of the processes of method 200 may be performed by a module, such as tutor service module 170. In some embodiments, one or more of processes 220, 265, 270, and/or 275 are optional and may be omitted. In some embodiments, process 265 and 270 may be performed concurrently and/or process 270 may be performed before process 265.

At a process 205, student information is received. In some examples, the student information may be received from a student, such as student 110, as part of a registration process and/or a periodic profile update process. In some examples, the student information may include one or more of contact information for the student, location information for the student (e.g., a city, a region, a school or university being attended, and/or the like), demographic information for the student, and/or the like. In some examples, the student information may further include information related to the learning style of the student. In some examples, the learning style may be determined based on results of a learning style assessment of the student performed during process 205. In some examples, process 205 may be performed multiple times for the student. In some examples, process 205 may be performed multiple times for multiple students. In some examples, the student information may be received via one or more messages, web forms, custom applications, remote procedure calls, service requests, and/or the like. In some examples, the received student information may be stored in a database, such as database 180.

At a process 210, tutor information is received. In some examples, the tutor information may be received from a tutor, such as tutor 120, as part of a registration process and/or a periodic profile update process. In some examples, the tutor information may include one or more of contact information for the tutor, location information for the tutor (e.g., a city, a region, a school or university where the tutor is familiar with courses and/or curricula, and/or the like), demographic information for the tutor, availability of the tutor (e.g., dates and times), and/or the like. The tutor information further includes a list of broad subject areas (e.g., algebra, economics, accounting, writing, foreign languages, and/or the like) that the tutor is able to tutor in. In some examples, the broad subject areas may be identified by a common subject matter identifier (e.g., algebra) and/or by a corresponding course offered by a school or university (e.g., MATH110). The tutor information further includes information about sub-subjects of the broad subject areas that the tutor is able to tutor in. In some examples, the sub-subjects may be selected from a list of sub-subjects associated with the broad subject areas (e.g., fractions, factoring, exponents, logarithms, and/or the like for algebra) or based on lectures and/or lecture topics for a specific course that identifies the broad subject area. In some examples, the tutor information may further include information related to the teaching style of the tutor. In some examples, the teaching style may be determined based on results of a teaching style assessment of the tutor performed during process 210. In some examples, process 210 may be performed multiple times for the tutor. In some examples, process 210 may be performed multiple times for multiple tutors. In some examples, the tutor information may be received via one or more messages, web forms, custom applications, remote procedure calls, service requests, and/or the like. In some examples, the received tutor information may be stored in a database, such as database 180.

At a process 215, a tutoring request is received. When a student is ready to receive tutoring, the student makes a tutoring request of the tutoring service. In the tutoring request, the student identifies a broad subject area for which tutoring is sought, a list of locations where the student is able to receive tutoring, and a list of dates and times when the student would like to receive tutoring. In some examples, as part of the tutoring request, the student provides one or more samples of the types of problems and/or assignments for which the student would like to receive tutoring. In some examples, as part of the tutoring request, the student provides a brief summary of the specific types of problems, sub-subjects, and/or the like for which the student would like to receive tutoring. In some examples, the sub-subjects may be selected from a list of sub-subjects associated with the broad subject matter. In some examples, the list may be the same list used by tutors to select the areas they can tutor in. In some examples, the tutoring request may be received via one or more messages, web forms, custom applications, remote procedure calls, service requests, and/or the like.

At an optional process 220, the tutoring request is analyzed. In some examples, one or more of the sample problems, the sample assignments, and/or the student provided summary may be analyzed to identify the sub-subjects that are most likely to be part of the tutoring request received during process 215. In some examples, the analyzing may include key word matching to known key words and/or key phrases associated with the sub-subjects of the broad subject area of the tutoring request. In some examples, a specially trained classification system (e.g., a trained neural network model) may be used to perform part of the analyzing. In some examples, the analyzing of the student provided summary may identify one or more sub-subjects that are precursor and/or foundational sub-subjects that are not specifically associated with the sub-subjects of the samples problems and/or the sample assignments (e.g., identifying exponents as a pre-cursor to logarithms, etc.)

At a process 225, a search for one or more matching tutors is performed. The search includes searching for one or more tutors that meet the logistical components of the tutoring request received during process 215. Meeting the logistical components includes matching tutors based on location (e.g., matching the locations provided by tutors during process 210 and the location provided by the student during process 215) and matching tutors based on availability (e.g., matching the date and time availability provided by tutors during process 210 and the date and time provided by the student during process 215). The search further includes searching for one or more tutors that also match the subject matter components of the tutoring request received during process 215. In some examples, this includes matching not just the broad subject area (e.g., matching the broad subject area provided by tutors during process 210 and the broad subject area provided by the student during process 215) but also the sub-subjects (e.g., matching the sub-subjects provided by tutors during process 210 and the sub-subjects provided by the student during process 215 and/or the identified during the analyzing of process 220). In some examples, the searching may be performed using one or more queries on a database, such as database 180. When no matching tutors are found, method 200 returns to process 215 to request that the student provide a revised tutoring request. If one or more matching tutors are found, they are further processed beginning with a process 230.

At the process 230, the one or more matching tutors are ranked. In some examples, the one or more tutors that match the tutoring request as identified during process 225 are ranked in order to find the most appropriate tutor or tutors for the student making the request. In some examples, a ranking algorithm may be applied to each of the one or more matching tutors that accounts for the ability of each of the tutors to tutor in the broad subject area of the tutoring request, the sub-subjects of the tutoring request, and/or to the learning style of the student making the tutoring request.

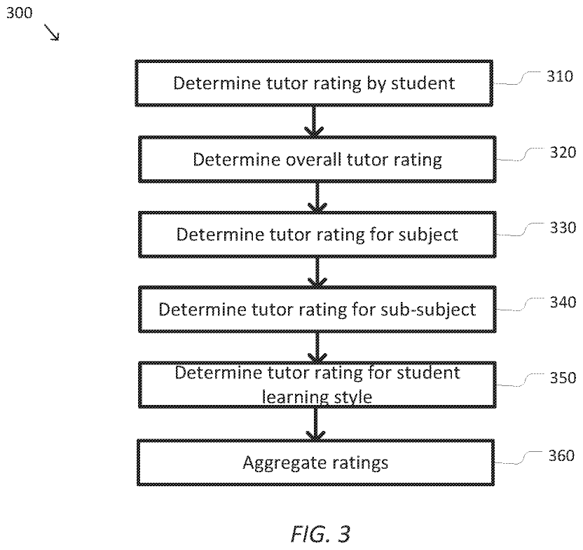

FIG. 3 is a simplified diagram of a method 300 of ranking a tutor according to some embodiments. One or more of the processes 310-360 of method 300 may be implemented, at least in part, in the form of executable code stored on non-transitory, tangible, machine-readable media that when run by one or more processors (e.g., the processor 150 in server 140) may cause the one or more processors to perform one or more of the processes 310-360. In some embodiments, one or more of the processes of method 300 may be performed by a module, such as tutor service module 170. In some embodiments, method 300 utilizes one or more ratings of tutors provided by students following previous tutoring sessions. In some examples, each of the ratings may be a numeric value and/or a Likert scale value (e.g., on a range from 0 to 4, a range from 1 to 5, a range from 1 to 10, and/or the like). In some examples, the one or more ratings may be stored in a database, such as database 180.

At a process 310, a tutor rating by student is determined. The tutor rating by student considers previous ratings of the tutor being ranked that were previously provided by the student making the tutoring request. Thus, the tutor rating by student provides an evaluation of how effective the specific tutor was during previous tutoring sessions between the student and the tutor. In some examples, when there has been more than one tutoring session between the student and the tutor, the rating may be an aggregate rating, such as an average, of the separate ratings.

At a process 320, an overall tutor rating is determined. The overall tutor rating considers that ratings provided by all students of the tutor. Thus, the overall tutor rating provides an evaluation of how effective the tutor is across tutoring sessions for all students. In some examples, when there has been more than one rating of the tutor, the overall rating may be an aggregate rating, such as an average, of the separate ratings.

At a process 330, a tutor rating for subject is determined. The tutor rating for subject considers the ratings provided by all students of the tutor for the broad subject matter of the tutoring request. Thus, the tutor rating for subject provides an evaluation of how effective the tutor is at tutoring in the broad subject matter. In some examples, when there has been more than one rating of the tutor for the broad subject matter, the rating for subject may be an aggregate rating, such as an average, of the separate ratings.

At a process 340, a tutor rating for sub-subject is determined. The tutor rating for sub-subject considers the ratings provided by all students of the tutor for the sub-subject or sub-subjects of the tutoring request. Thus, the tutor rating for sub-subject provides an evaluation of how effective the tutor is at tutoring in each of the sub-subjects. In some examples, when there has been more than one rating of the tutor for a sub-subject, the rating for the sub-subject may be an aggregate rating, such as an average, of the separate ratings. In some examples, when the tutoring request is associated with multiple sub-subjects process 340 may be repeated to determine a tutor rating for sub-subject for each of the sub-subjects with the ratings for each of the sub-subjects being aggregated together (e.g., via averaging).

At a process 350, a tutor rating for student learning style is determined. The tutor rating for student learning style considers the ratings of the tutor provided by all students having a same learning style as the student making the tutoring request. Thus, the tutor rating for student learning style provides an evaluation of how effective the tutor is at tutoring students with the same learning style as the student making the tutoring request. In some examples, when there has been more than one rating of the tutor for a student learning style, the rating for student learning style may be an aggregate rating, such as an average, of the separate ratings. In some examples, when the tutor has not previously tutored a student with a same learning style as the student making the tutoring request, a general rating may be provided that considers how well tutors with the teaching style of the tutor are able to tutor students with the learning style of the student making the tutoring request. In some examples, the general rating may be determined by aggregating ratings of tutors with the teaching style of the tutor that have been made by students with the learning style of the student making the tutoring request.

At a process 360, the ratings determined during processes 310-350 are aggregated. In some examples, the aggregation may include averaging the ratings determined by processes 310-350, performing a weighted sum of the ratings determined by processes 310-350 that favors one rating over another, and/or the like. In some examples, the ratings determined processes 310-350 may be weighted based on a number of ratings used in the aggregations of each of the ratings determined processes 310-350. In some examples, the aggregation of the ratings determined processes 310-350 may be determined using a deep learning model, such as a neural network, that is trained as is described in further detail below.

Referring back to FIG. 2 and process 230, method 300 may be applied to each of the one or more tutors that match the tutoring request as identified during process 225 to determine a rating of how each of the tutors matches the subject matter and the student making the tutoring request. In some examples, the ratings may be used to rank and/or order each of the one or more tutors that match the tutoring request.

At a process 235, a list of tutors is sent to the student. In some examples, the list of tutors may include each of the one or more tutors that match the tutoring request as identified during process 225. In some examples, the list is sorted based on the ratings and rankings determined during process 230. In some examples, the list includes the ranking of each of the tutors so that the student can evaluate how suitable each of the tutors is to the tutoring request. In some examples, the list of tutors may be returned to the student as a response to the tutoring request, returned in an email, and/or some similar mechanism. In some examples, once the student receives the list, the student may access a profile of one or more of the tutors on the list provided by the tutoring service. The profile may provide some of the information provided by the tutor during process 210 and/or other information such as how long the tutor has been tutoring for the tutoring service, how many students the tutor has tutored, comments may by other students about the tutor, and/or the like.

At a process 240, a selection of one or more acceptable tutors is received from the student. After reviewing the list of tutors provided during process 235, the student provides a list of tutors that the student considers acceptable. In some examples, the student may identify the one or more acceptable tutors by marking corresponding check boxes, and/or the like and submitting the selection to the tutoring service. In some examples, the request to the student to make the selection may be sent via an alert, such as an email, a text message, an automated voice call, and/or the like. In some examples, the selection may be made by clicking on a URL in the selection request, selecting one or more check boxes, and/or the like, via one or more web forms, via one or more custom applications, via one or more remote procedure calls, via one or more service requests, and/or the like.

At a process 245, a job notification is sent to each of the one or more acceptable tutors. In some examples, the job notification may be sent to each respective tutor using the contact information provided by the respective tutor during process 210. In some examples, the job notification may be sent via any suitable alerting service, such as an email, a text message, an automated voice call, and/or the like. In some examples, the job notification may include a limited time period in which the job notification remains valid and/or by which a response should be received in order to be further considered by the student making the tutoring request. In some examples, the job notification may include profile information on the student (such as some of the information received during process 205, a number of times the student has used the tutoring service, and/or the like) and information about the tutoring request including one or more of the broad subject area, the sub-subjects, the sample problems and/or assignments, and/or the requested dates and times.

At a process 250, a response to the job notification is received from one or more of the tutors. In some examples, the response may be received as a result of a tutor clicking on a URL in the job notification, pressing a button, and/or the like in the job notification, logging into the tutoring service and responding, and/or the like. In some examples, when no response is received, the student may be informed and method 200 may return to process 235 to ask the student to select different acceptable tutors and/or to process 215 to have the student update the tutoring request.

At a process 255, tutor selection occurs. In some examples, the tutor selection may include sending, to the student, a list of each of the one or more tutors that timely responded with an affirmative answer to the job notification during process 250, and receiving a selection of a tutor by the student. Once the student has selected a tutor, a confirmation may be sent to the student and the tutor (e.g., an alert such as a text message, an email, an automated voice call, and/or the like). In some examples, the selection may be made by clicking on a URL in the selection request, selecting one or more check boxes, and/or the like, via one or more web forms, via one or more custom applications, via one or more remote procedure calls, via one or more service requests, and/or the like. In some examples, the tutoring service may also help facilitate the scheduling of a specific time and/or place for the tutoring. In some examples, the tutoring service may also help establish communication between the student and the selected tutor by connecting them via a chat service, a teleconferencing system, a video conferencing system, and/or the like. In some examples, the chat service, the teleconferencing system, the video conferencing system, and/or the like may be integrated into the tutoring service.

At a process 260, the tutor provides the requested tutoring to the student.

At an optional process 265, after the tutoring is complete, feedback from the student about the tutor is requested and received. In some examples, the feedback may be requested in the form of a survey, a questionnaire, a rating rubric, and/or the like that solicits information about the tutor including overall ratings of the tutor, ratings for the broad subject area, ratings for each of the sub-subject, ratings based on learning and/or teaching styles, and/or the like. In some examples, the feedback may be received as scored on a numeric scale, a Likert scale, and/or the like. In some examples, the feedback and/or ratings received may correspond to the ratings used during process 230 and/or method 300. In some examples, the feedback from the student may be solicited by sending an alert, such as an email, a text message, an automated voice call, and/or the like. In some examples, the feedback may be returned by the student using one or more web forms, one or more custom applications, one or more remote procedure calls, one or more service requests, and/or the like.

At an optional process 270, after the tutoring is complete, feedback from the tutor about the student is requested and received. In some examples, the feedback may be requested in the form of a survey, a questionnaire, a rating rubric, and/or the like that solicits information about the student including how engaged the student was, how prepared the student was for the tutoring, and/or the like. In some examples, the feedback may be received as scored on a numeric scale, a Likert scale, and/or the like. In some examples, the feedback from the tutor may be solicited by sending an alert, such as an email, a text message, an automated voice call, and/or the like. In some examples, the feedback may be returned by the tutor using one or more web forms, one or more custom applications, one or more remote procedure calls, one or more service requests, and/or the like.

At an optional process 275, the feedback received during process 265 is stored. In some examples, the feedback may be stored in raw form in a database, such as database 180. In some examples, the feedback may be tagged and/or coded to reflect whether the ratings in the feedback correspond to the specific student, broad subject area, sub-subject, student learning style, and/or the like. In some examples, the feedback received from the tutor during process 270 may be used to adjust and/or qualify the feedback received from the student during process 265. For example, ratings from a student that was weakly engaged, poorly prepared, and/or poorly identified the subject areas for tutoring may be weighted and/or discounted so that its impact on the aggregate ratings for the tutor are reduced relative to ratings from other students and/or other tutoring sessions. In some examples, when process 230 and/or method 300 use a deep learning model (e.g., a neural network) to determine the aggregate ratings, the deep learning model may be further trained based on the predicted rating and/or ranking for the tutor (as determined during process 230 and/or method 300) and the actual ratings of the tutor provided in the feedback received from the student during process 215.

According to some embodiments, processes 215-275 may be performed for each of multiple tutoring requests either serially and/or concurrently as multiple students make tutoring requests, a same student makes multiple tutoring requests, and/or the like.

As discussed above and further emphasized here, FIGS. 1-3 are merely examples which should not unduly limit the scope of the claims. One of ordinary skill in the art would recognize many variations, alternatives, and modifications. In some embodiments, the structures of FIG. 1 and/or the methods of FIGS. 2 and 3 may be adapted to arrangements and services other than those between a tutor and a student for the provision of tutoring services. In some examples, FIG. 1-3 may also be used to coordinate mentoring between mentors and mentees. In some examples, the two representative users of computing system 100 may be a mentee instead of student 110 and a mentor instead of a tutor 120. In some examples, tutor service module 170 may be adapted to help facilitate mentoring between the mentor and the mentee. In some examples, tutor service module 170 as adapted for mentoring is responsible for maintaining information about the users of a mentoring service (e.g., mentees and mentors), taking requests from mentees for mentoring in specific areas of expertise, identifying mentors suitable for the request, coordinating the selection of an acceptable mentor by the mentee making the request, and collecting post-mentoring feedback that may be used to improve the selection of future mentors for mentees.

In some embodiments, method 200 may be adapted to become a method of providing mentoring. In some examples, process 205 may be adapted to receive mentee information. In some examples, the mentee information may be received from a mentee and/or include mentee information similar to the student information and/or may additionally include a list of schools and/or universities to which the mentee has attended and/or graduated, a list of previous employers, and/or the like. In some examples, process 210 may be adapted to receive mentor information. In some examples, the mentor information may be received from a mentor and/or may include mentor information similar to the tutor information and/or may additionally include a list of schools and/or universities to which the mentor has attended and/or graduated, a list of previous employers, and/or the like. In some examples, the tutor information may be extracted from one or more biographies, resumes, and/or curriculum vitae for the mentor. In some examples, the tutor information may include one or more areas of expertise and/or experience, one or more sub-areas of expertise and/or experience, and/or the like.

In some examples, process 215 may be adapted to receive a mentoring request. In some examples, the mentoring request may optionally include a list of one or more areas of expertise and/or experience in which the mentee would like mentorship. In some examples, optional process 220 may be adapted to analyze the mentoring request. In some examples, process 225 may be adapted to perform a search for one or more matching mentors. In some examples, the search may include matching areas and/or sub-areas of expertise and/or experience. In some examples, process 230 may be adapted to rank the one or more matching mentors. In some examples, the ranking may be performed using an adapted version of method 300.

In some examples, process 310 may be adapted to determine a mentor rating by mentee based on ratings of the mentor being ranked that were previously provided by the mentee making the mentoring request. In some examples, process 320 may be adapted to determine an overall mentor rating based on ratings by all of the mentees of the mentor being ranked. In some examples, process 330 may be adapted to determine a mentor rating for an area of expertise and/or experience based on previous ratings of the mentor being ranked based on ratings by mentees for the area of expertise and/or experience. In some examples, process 340 may be adapted to determine a mentor rating for a sub-area of expertise and/or experience based on ratings of the mentor being ranked by mentees for the sub-area of expertise and/or experience. In some examples, process 350 may be adapted to determine a mentor rating for mentee learning style based on ratings provided by other mentees having a same learning style as the mentee for which the mentor is being ranked. In some examples, process 360 may be adapted to aggregate the various mentor ratings.

In some examples, process 235 may be adapted to send a list of mentors to the mentee. In some examples, process 240 may be adapted to receive a selection of one or more acceptable mentors. In some examples, process 245 may be adapted to send a mentorship request to each of the one or more acceptable mentors. In some examples, process 250 may be adapted to receive a response to the mentorship request from one or more of the mentors. In some examples, process 255 may be adapted to facilitate mentor selection. In some examples, mentoring is provided by the selected mentor to the mentee during a modified version of process 260.

In some examples, optional process 265 may be adapted to request and receive feedback from the mentee about the mentor after the mentorship is complete. In some examples, the feedback may include ratings of the mentor by the mentee based on the areas and/or sub-areas of expertise and/or experience. In some examples, optional process 270 may be adapted to request and receive feedback from the mentor about the mentee after the mentorship is complete. In some examples, optional process 275 may be adapted to store the feedback received during the adapted versions of processes 265 and/or 270.

Some examples of computing devices, such as server 140 may include non-transitory, tangible, machine-readable media that include executable code that when run by one or more processors (e.g., processor 150) may cause the one or more processors to perform the processes of methods 200 and/or 300. Some common forms of machine-readable media that may include the processes of method 200 and/or 300 are, for example, floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method performed by a processor for coordinating mentoring, the method comprising:
receiving a mentoring request from a mentee, the mentoring request identifying one or more areas or sub-areas of expertise or experience and logistical information;
matching one or more mentors to the mentoring request based on the one or more areas or sub-areas of expertise or experience and the logistical information;
ranking each of the one or more mentors matching the mentoring request based on an aggregation of ratings for each respective mentor, the ratings being based on previous feedback about each respective mentor received based on previous mentoring;
providing a list of the one or more mentors matching the mentoring request and the ranking to the mentee;
receiving a selection of one or more acceptable mentors from the list of the one or more mentors matching the mentoring request from the mentee;
sending a mentorship request to each of the one or more acceptable mentors;
receiving responses from one or more of the one or more acceptable mentors;
sending a list of the one or more acceptable mentors providing an affirmative response to the mentee;
receiving a selection of a mentor from the list of the one or more acceptable mentors providing an affirmative response from the mentee; and
facilitating scheduling of mentoring between the mentee and the selected mentor.

2. The method of claim 1, further comprising receiving feedback from the mentee about the selected mentor after the mentoring.

3. The method of claim 2, further comprising using the feedback to update a plurality of ratings of the selected mentor.

4. The method of claim 3, further comprising weighting the plurality of ratings of the selected mentor based on feedback from the selected mentor about the mentee.

5. The method of claim 2, further comprising using the feedback to train a deep learning model used during the ranking.

6. The method of claim 1, further comprising receiving feedback from the selected mentor about the mentee after the mentoring.

7. The method of claim 1, wherein the ratings for each respective mentor include a plurality of ratings selected from previous rating of the respective mentor by the mentee, an overall rating of the respective mentor, a rating of the respective mentor for mentorship of one or more areas or sub-areas of expertise or experience, or a rating of the respective mentor for mentoring mentees having a same learning style as the mentees.

8. A computing device comprising:
a memory; and
a processor coupled to the memory and configured to:
receive a mentoring request from a mentee, the mentoring request identifying one or more areas or sub-areas of expertise or experience and logistical information;
match one or more mentors to the mentoring request based on the one or more areas or sub-areas of expertise or experience and the logistical information;
rank each of the one or more mentors matching the mentoring request based on an aggregation of ratings for each respective mentor, the ratings being based on previous feedback about each respective mentor received based on previous mentoring;
provide a list of the one or more mentors matching the mentoring request and the ranking to the mentee;
receive a selection of one or more acceptable mentors from the list of the one or more mentors matching the mentoring request from the mentee;
send a mentorship request to each of the one or more acceptable mentors;
receive responses from one or more of the one or more acceptable mentors;
send a list of the one or more acceptable mentors providing an affirmative response to the mentee;
receive a selection of a mentor from the list of the one or more acceptable mentors providing an affirmative response from the mentee; and
facilitate scheduling of mentoring between the mentee and the selected mentor.

9. The computing device of claim 8, wherein the processor is further configured to receive feedback from the mentee about the selected mentor after the mentoring.

10. The computing device of claim 9, wherein the processor is further configured to use the feedback to update a plurality of ratings of the selected mentor.

11. The computing device of claim 10, wherein the processor is further configured to weight the plurality of ratings of the selected mentor based on feedback from the selected mentor about the mentee.

12. The computing device of claim 9, wherein the processor is further configured to use the feedback to train a deep learning model used during the ranking.

13. The computing device of claim 8, wherein the processor is further configured to receive feedback from the selected mentor about the mentee after the mentoring.

14. The computing device of claim 8, wherein the ratings for each respective mentor include a plurality of ratings selected from previous rating of the respective mentor by the mentee, an overall rating of the respective mentor, a rating of the respective mentor for mentorship of one or more areas or sub-areas of expertise or experience, or a rating of the respective mentor for mentoring mentees having a same learning style as the mentees.

15. A non-transitory machine-readable medium comprising a plurality of machine-readable instructions which when executed by one or more processors associated with computing device are adapted to cause the one or more processors to perform a method comprising.
receiving a mentoring request from a mentee, the mentoring request identifying one or more areas or sub-areas of expertise or experience and logistical information;
matching one or more mentors to the mentoring request based on the one or more areas or sub-areas of expertise or experience and the logistical information;
ranking each of the one or more mentors matching the mentoring request based on an aggregation of ratings for each respective mentor, the ratings being based on previous feedback about each respective mentor received based on previous mentoring;
providing a list of the one or more mentors matching the mentoring request and the ranking to the mentee;
receiving a selection of one or more acceptable mentors from the list of the one or more mentors matching the mentoring request from the mentee;
sending a mentorship request to each of the one or more acceptable mentors;
receiving responses from one or more of the one or more acceptable mentors;
sending a list of the one or more acceptable mentors providing an affirmative response to the mentee;
receiving a selection of a mentor from the list of the one or more acceptable mentors providing an affirmative response from the mentee; and
facilitating scheduling of mentoring between the mentee and the selected mentor.

16. The non-transitory machine-readable medium of claim 15, further comprising receiving feedback from the mentee about the selected mentor after the mentoring.

17. The non-transitory machine-readable medium of claim 16, further comprising using the feedback to update a plurality of ratings of the selected mentor.

18. The non-transitory machine-readable medium of claim 17, further comprising weighting the plurality of ratings of the selected mentor based on feedback from the selected mentor about the mentee.

19. The non-transitory machine-readable medium of claim 16, further comprising using the feedback to train a deep learning model used during the ranking.

20. The non-transitory machine-readable medium of claim 15, wherein the ratings for each respective mentor include a plurality of ratings selected from previous rating of the respective mentor by the mentee, an overall rating of the respective mentor, a rating of the respective mentor for mentorship of one or more areas or sub-areas of expertise or experience, or a rating of the respective mentor for mentoring mentees having a same learning style as the mentees.
